(19) United States
(12) Patent Application Publication
(10) Pub. No.: US 2006/0109118 A1
(43) Pub. Date: May 25, 2006

(54) Twist-tie RFID tag

(75) Inventors: Mark Pelo, Macy, IN (US); Steven M. Tethrake, North Webster, IN (US); Jeffrey H. Nycz, Collierville, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: SDGI Holdings, Inc.

(21) Appl. No.: 10/993,488

(22) Filed: Nov. 22, 2004

(51) Int. Cl. G08B 13/14

(52) U.S. Cl. 340/572.1

(57) ABSTRACT

An RFID tag that incorporates at least one integral or permanently attached twist-tie fastener for easy attachment, detachment and reattachment to various items to be inventoried is provided. The RFID tag is included at least partially in a protective housing to permit it to be utilized in hostile environments. The twist-tie portion is attached to the tag and preferably is constructed of a braided or single strand wire. One or more visual indicia also may be printed on the face of the protective housing.

### FIELD OF THE INVENTION

The invention generally relates to RF inventorying techniques and more specifically to a new and useful reusable twist-tie RFID transponder tag for easy attachment, detachment and reattachment to a variety of different shaped devices and equipment. The RFID transponder tag can be applied, in particular, to medical and surgical devices and equipment.

### BACKGROUND OF THE INVENTION AND DESCRIPTION OF RELATED ART

Electronic data carrying memory devices are known. These devices provide a method for tracking and providing information about items. Memory devices permit linking of large amounts of data with an object or item. They typically include a memory and logic in the form of an integrated circuit (“IC”) and a mechanism for transmitting data to and/or from the product or item attached to the memory device. An example of such a memory device-based product identification technology is radio frequency identification (RFID).

Radio frequency identification (RFID) systems use an RF field generator (reader) and a plurality of RFID tags that store information about the goods and products to which they are attached. RFID tags are miniature electronic circuits that typically consist of a coil that acts as an antenna and a small silicon-based microprocessor with a memory all encapsulated in a sealing material. RFID tags store identification information, usually in the form of an identification number. When a transponder tag enters an RF field generated by a reader device, the circuit of the tag becomes energized causing the processor to perform a data operation, usually by emitting a signal containing the processor's stored information. The basic structure and operation of RFID tags can be found in, for example, U.S. Pat. Nos. 4,075,632, 4,360,801, 4,390,880, 4,739,328 and 5,030,807, the disclosures of which are hereby incorporated by reference in their entirety.

RFID tags generally are formed on a substrate and can include, for example, analog RF circuits, digital logic, and memory circuits. RFID tags also can include a number of discrete components, such as capacitors, transistors, and diodes. RFID tags are categorized as either active or passive. Active tags have their own discrete power source such as a battery. When an active tag enters an RF field it is turned on and then emits a signal containing its stored information. Passive tags do not contain a discrete power source. Rather, they become inductively or capacitively charged when they enter an RF field. Once the RF field has activated the passive circuit, the passive tag emits a signal containing its stored information. Passive RFID tags usually include an analog circuit that detects and decodes the interrogating RF signal and that provides power from the RF field to a digital circuit in the tag. The digital circuit generally executes all of the data functions of the RFID tag, such as retrieving stored data from memory and causing the analog circuit to modulate to the RF signal to transmit the retrieved data. In addition to retrieving and transmitting data previously stored in the memory, both passive and active dynamic RFID tags can permit new or additional information to be stored in the RFID tag's memory, or can permit the RFID tag to manipulate data or perform some additional functions.

Though originally invented to track feeding of cattle, RFID tags are today utilized in a variety of applications including retail security, inventory management, and even computerized checkout. With the price of RFID tags now reaching as low as 5 cents per tag, and because of reductions in size due to an overall trend towards miniaturization in circuit design, RFID tags currently are being applied to many types of products, both at the consumer level as well as in manufacturing processes. RFID tags enable manufacturers to wirelessly track products from the manufacturing stage to the point-of-sale. They provide a robust, cost effective, efficient and accurate solution to inventory tracking and management.

Current commercially available RFID tags, both active and passive, come in one of two configurations: inductively or capacitively coupled. Inductively coupled tags, the first type of RFID tags developed, consist of a silicon-based microprocessor, a metal coil wound into a circular pattern which serves as the tag's antenna, and an encapsulating material that wraps around the chip and coil. These tags are powered by an electromagnetic field generated by the tag reader. The tag's antenna picks up the electromagnetic energy which in turn powers the chip. The tag then modulates the electromagnetic field in order to transmit data back to the reader. Despite advances in silicon manufacturing processes, inductively coupled tags have remained relatively expensive due to the coil antenna and the manufacturing process required to wind the coil around the surface of the tag.

The second type of RFID tags are capacitively coupled RFID tags. Capacitively coupled tags eliminate the metal coil, consisting instead of a silicon microprocessor, paper substrate, and a conductive carbon ink that is applied to the paper substrate through a conventional printing means. By using conductive ink and conventional printing processes, a relatively low cost, disposable tag can be created that is easily integrated into conventional product labels.

RFID tags are rapidly becoming the preferred method of inventory tracking in retail and distribution applications and will likely surpass bar codes as the preferred point-of-sale checkout identifier. Large retail chains such as WALMART Corporation are already requiring their suppliers to utilize RFID tags for tracking shipments. They have significant advantages over bar code labels. For example, bar codes are limited in size by resolution limitations of bar code scanners, and the amount of information that the symbols can contain is limited by the physical space constraints of the label. Therefore, some objects may be unable to accommodate bar code labels because of their size and physical configuration. In contrast, RFID tags store their information in digital memory. Thus, they can be made much smaller than bar code tags.

Another advantage of RFID tags over bar codes is that bar code readers requires line of sight in order to read the reflection pattern from a bar code. As labels become worn or damaged, they can no longer be read with the bar code scanner. Also, because a person operating the bar code scanner must physically orient either the scanner or the product to achieve line of sight on each item being scanned, items must be scanned one at a time resulting in prolonged scan time. RFID tags, on the other hand, are read through radio waves, which do no require line of sight because they are able to penetrate light impermeable materials. This not only eliminates the line of sight requirement, but also allows rapid identification of a batch of tagged products.

Yet another relative advantage of RFID tags over bar code labels is that for dynamic RFID tags, the information stored in the tag may be updated using a writing device to wirelessly transmit the new information to be stored. Updating information in bar code tags typically requires printing a new tag to replace the old.

A problem of RFID tags, which also is common to bar code tags is that it can be difficult to securely attach the tags to various goods and products. As discussed above, capacitively coupled RFID tags usually are printed on a paper substrate and then attached to various items using an adhesive bonding. However, in some applications, a paper tag may not hold up to the rigors of the application environment. For example, in the field of medical equipment, and in particular, surgical instruments and surgical instrument storage and sterilization systems, items are routinely exposed to environments containing various combinations of high temperatures, high pressure and liquid and/or gaseous chemical sterilants. Over time, a paper RFID tag would not provide reliable performance under these harsh conditions. More rugged RFID tags have been developed as a potential solution to this problem. An example of a rugged RFID tag is provided in U.S. Pat. No. 6,255,949, the disclosure of which is hereby incorporated by reference in its entirety. The '949 patent discloses an RF transponder tag surrounded by a thermally resistant polymer and encapsulated in a hardened case. Because radio frequency waves can penetrate such materials, performance of the tag is not degraded by the case or polymer. Such a configuration prevents damage to the transponder tag if exposed to high temperature environments.

While making the tag enclosure more rugged protects the internal components of the tag, this still does not solve the problem of keeping the tag securely attached, particularly in harsh environments. As discussed above, substrate based tags, even rugged tags, are typically mounted using an adhesive. This presents at least two problems for the application of tags exposed to harsh environments. First, adhesives will break down and lose their adhesive property when they are exposed to heat and moisture. This limits their usage to dry “friendly” environments. Second, adhesives require a flat surface on which to mount the RFID tags. This precludes the mounting of tags onto devices, equipments, or containers that do not have a flat surface of sufficient dimensions. Furthermore, many items do not have geometrically shaped portions sufficiently large to accommodate such a substrate based tag. Thus, for at least these reasons, adhesives do not provide a robust solution for attaching RFID tags.

A proposed solution to the above described attachment problem has been to integrate the RFID tag into a bracelet or strap. This can be particularly useful for patient or personal monitoring systems. U.S. Pat. No. 6,104,295 describes such an electronic band having an integral RFID tag. However, a problem with this solution is that the band width will preclude application of the bracelet to small items. Also, because the portion of the band defined by the tag is rigid, this will dictate the minimum width that the band strap can be adjusted to. Thus, for items having a small diameter, only a loose fitting will be possible.

The description herein of various advantages and disadvantages associated with known apparatus, methods, and materials is not intended to limit the scope of the invention to their exclusion. Indeed, various embodiments of the invention may include one or more of the known apparatus, methods, and materials without suffering from their disadvantages.

### SUMMARY OF THE INVENTION

There exists a need for an RFID tag and attachment system that ameliorates some of all of the above-noted deficiencies of previous RFID tag and attachment systems. Embodiments of the present invention mitigate or solve the above-identified limitations, as well as other unspecified deficiencies. A number of advantages associated with various embodiments of the present invention will be readily evident to those skilled in the art, including economy of design and resources, transparent operation, cost savings, etc.

In one exemplary embodiment of this invention, an RFID transponder tag is provided that comprises a tag housing including of a protective outer casing, a RFID transponder circuit located in the tag housing, and at least one twist-tie cable that is either integral to or permanently attached to the tag housing. In this embodiment, the at least one twist-tie cable allows the transponder tag to be attached, detached and reattached to an item.

In another exemplary embodiment of this invention, a reusable identification tag is provided that comprises a protective housing and an electronic circuit positioned at least partially inside the protective housing that comprises at least a digital memory. The tag according to this embodiment further comprises at least one twist-tie cable integral or permanently attached to the housing for attaching the identification tag to an item.

In yet another exemplary embodiment of this invention, an article of manufacture is provided that comprises an outer casing, an electronic circuit positioned at least partially within the outer casing, and comprising a digital memory, and an attachment means for attaching the article to an item.

An additional embodiment of the invention provides, a method of manufacturing an identification tag. The method comprises encapsulating an RFID transponder tag in a protective housing and permanently attaching at least one twist-tie cable to a position of the housing.

These and other aspects and advantages of the invention will become apparent from the following detailed description, taken in conjunction with the accompanying drawings, illustrating by way of example the principles of the invention.

### BRIEF DESCRIPTION OF THE DRAWINGS

Purposes and advantages of the present invention will be apparent to those of ordinary skill in the art from the following detailed description in conjunction with the appended drawings in which like reference characters are used to indicate like elements, and in which:

FIG. 1 a schematic diagram of a twist-tie RFID transponder tag according to at least one embodiment of this invention;

FIG. 2 is an exploded cross-sectional view of a twist-tie RFID transponder tag according to at least one,embodiment of this invention;

FIG. 3 is a top down schematic view of the internal components of a twist-tie RFID transponder tag according to at least one embodiment of this invention;

FIG. 4 is a schematic drawing illustrating the attachment of a twist-tie RFID transponder tag to a generally circular member according to at least one embodiment of this invention; and

FIG. 5 is a schematic drawing illustrating a twist-tie RFID transponder tag having two twist-tie portions in accordance with at least one embodiment of this invention.

### DETAILED DESCRIPTION OF THE DISCLOSURE

The following description is intended to convey a thorough understanding of the invention by providing specific embodiments and details involving RFID identification systems. It is understood, however, that the invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

Throughout this description, the expression “RFID transponder tag” will be given broad meaning including, but not limited to, any active or passive type of electronic data storage device that is wirelessly activated in the presence of a radio frequency (RF) field including any currently available inductively coupled tags, capacitively coupled tags and even future RF-type tags not yet available.

Throughout this description, the expression “twist-tie RFID transponder tag” will be given broad meaning including, but not limited to, any type of RFID transponder tag that is encapsulated in a protective casing and that includes at least one integral flexible wire that may be securely twisted around an object having a member with a circumference less than the length of the at least one wire.

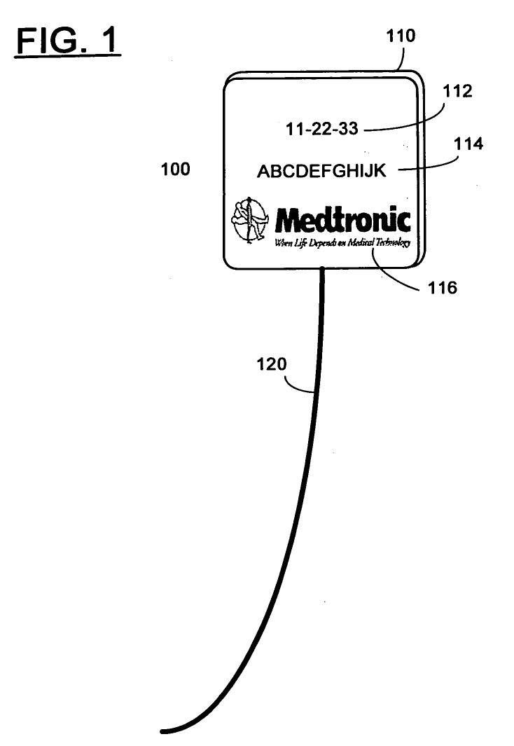

Referring now to FIG. 1, a twist-tie RFID transponder tag 100 is illustrated in accordance with one exemplary embodiment of this invention. As shown in FIG. 1, the twist-tie RFID transponder tag 100 includes a tag housing 110 and a twist-tie cable 120. The tag housing 110 preferably is made of a durable material such as a low weight, durable material that is resistant and more preferably impervious to liquids, and that provides protection against crushing of internal tag components. Various polymeric, metallic, ceramic and alloy materials may be suitable for the construction of the tag housing 110. The twist-tie cable 120 preferably is made of a stainless steel, titanium, aluminum or other non-corrosive single strand or braided material that is flexible yet non-resilient in order to facilitate secure attachment, detachment and reattachment to various items having potentially different physical dimensions without degradation of integrity.

The twist-tie RFID transponder tag 110 is illustrated having a housing with a roughly square shape. It should be appreciated that this roughly square shape is shown for illustrative purposes only. The tag housing 110 may be rectangular, circular, oval or any other suitable shape without departing from the spirit or scope of this invention. FIG. 1 depicts various printed indicia on a face of the tag housing 110. FIG. 1 depicts indicia include a numeric indicia 112, such as a part or item identification number, a textual indicia 114 such as a product name or product category name, and a brand indicia 116, such as a manufacturer name of the RFID tag or the item to which the tag is attached. In various exemplary embodiments, all three indicia are utilized. However, in various other embodiments, less then three indicia are utilized. In still further embodiments, more than three indicia are utilized or no indicia at all are utilized. In addition to these embodiments, other embodiments may utilize color coding, bar coding or other optically recognizable indicia. The present invention is compatible with any of the aforementioned indicia schemes.

Still referring to the twist-tie RFID transponder tag 100 of FIG. 1, during use, an operator will twist the twist-tie 120 of the transponder tag 100 around a portion of an item to be tagged. The portion will preferably be of sufficiently small dimensions to permit the twist-tie portion 120 to be bent several times around it to provide a secure attachment. The RFID trasponder tag 100 preferably is preprogrammed with identification information for the item to which it will be attached. Therefore, once tagged, the item may be wirelessly inventoried by activating the RFID transponder tag 100 using a suitable RF reader device. RFID reader devices are ubiquitously well known in the art. Therefore, a detailed discussion of such devices has been intentionally omitted. The twist-tie RFID transponder tag according to the present invention is compatible with any suitable reader devices whether hand held, stationary, fixed or otherwise configured.

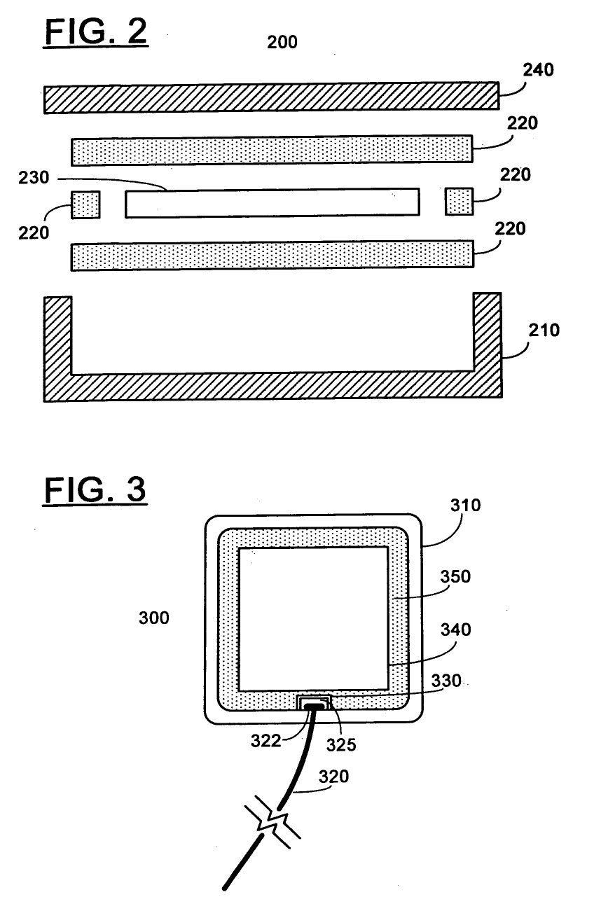

FIG. 2 is an exploded cross-sectional view of a twist-tie RFID transponder tag 200 according to at least one embodiment of this invention. In FIG. 2, the RFID transponder tag is shown comprising a main housing body portion 210, an insulating layer(s) 220, an RFID transponder layer 230 and a top housing body portion 240. In various exemplary embodiments, the transponder layer 230 preferably includes all internal electronic components of the RFID transponder tag. Also, in various exemplary embodiments, the insulating layer 220 will provide insulation to the transponder layer 230 including insulation against shocks and vibration and thermal insulation. Also, in a preferred embodiment, either the housing portions 210, 240 or the insulating layer 220 or both will provide a water impermeable barrier to the transponder layer 230. The RFID transponder layer 230 and the insulating layer 220 preferably are sealed in the housing portions 210, 240 using an adhesive seal, an injection molding process or other suitable encapsulating process. As shown in FIG. 2, more than one insulating layer 200 may be employed.

FIG. 3 is a top down schematic view of the internal components of a twist-tie RFID transponder tag 300 according to at least one embodiment of this invention. The twist-tie transponder tag 300 shown in FIG. 3 includes a protective housing 310, a twist-tie portion 320, an RFID transponder unit 340 and an insulating layer 350. As shown in the Figure, the twist-tie portion 320 is secured to the housing via flange 322 located at one end of the twist-tie portion, that is inserted into a recess 325 defined by an inner peripheral wall 330. As discussed above in the context of FIG. 1, the twist-tie portion preferably is comprised of a non-corrosive material such as stainless steel, aluminum, titanium or other rust resistant material. In an alternative configuration to that shown in FIG. 3, the twist-tie portion 320 may be embedded in the wall of the housing 310 and the recess 325 may be eliminated. The specific manner in which the twist-tie portion 320 is attached to housing body 310 is not critical to the invention. The invention is compatible with various means and methods of integrating the twist-tie portion 320 with the housing 310.

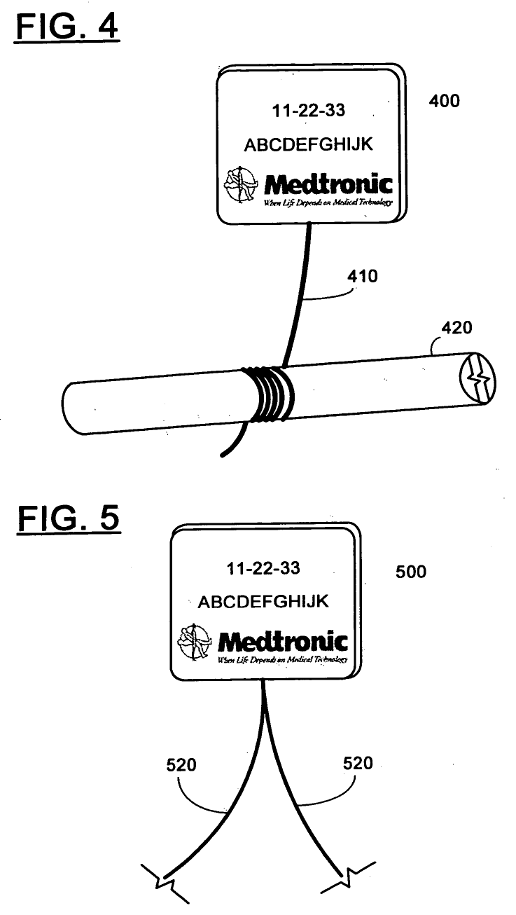

FIG. 4 illustrates a twist-tie RFID transponder tag 400 attached to a substantially circular member of an item to be tagged in accordance with at least one exemplary embodiment according to this invention. As shown in FIG. 4, to attach the tag 400 to the cylindrical member 420, a user merely twists the twist-tie portion 410 around the cylindrical member 420 one or more times depending on the dimensions of the twist-tie portion 410 relative to the cylindrical portion 420. In various exemplary embodiments, the cylindrical portion may be a handle, stem, tube, cord, dial, switch, knob, or other suitable cylindrically shaped member of an item to be tagged. Alternatively, in various other exemplary embodiments, the tag 400 may be threaded through a loop, ring, or other feature that will permit the tag 400 to be securely attached by twisting the twist-tie portion 400.

FIG. 5 illustrates an alternative configuration of the twist-tie RFID transponder tag 500 according to various embodiments of this invention. In FIG. 5, as opposed to the embodiment shown in FIG. 1, the twist-tie portion 520 includes two twist-tie portions 520, 520. By this configuration, the tag 500 may be attached to items having larger dimensions than if a single twist-tie portion were used. When attaching the tag 500 of this embodiment, each twist-tie portion may be wrapped around the chosen member and then the individual ends twisted around each other as is done with a traditional twist-tie fastener. Though not illustrated in the embodiment of FIG. 5, various visual indicia also may be present on one or more faces of the tag housing 510 as was discussed above in the context of FIG. 1. It should be appreciated that though the twist-tie transponder tag 500 illustrated in FIG. 5 includes two twist-tie portions 520, it may be desirable to use more than two twist-tie portions. Such a substitution may be made without departing from the spirit or scope of this invention.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed:

1. An RFID transponder tag comprising:
a tag housing comprising a protective outer casing;
an RFID transponder circuit positioned at least partially within the tag housing; and
at least one twist-tie cable integral to or permanently attached to the tag housing for attaching the transponder tag to an item.

2. The tag according to claim 1, further comprising an insulating material surrounding the transponder circuit.

3. The tag according to claim 1, further comprising one or more visual indicia on a face of the tag housing.

4. The tag according to claim 3, wherein the one or more indicia is selected from the group consisting of a brand owner name, a product name, a category name, a color code, a graphic image, a product identification number, a bar code and combination thereof.

5. The tag according to claim 1, wherein the RFID transponder circuit comprises an antenna, a microprocessor and a digital memory.

6. The tag according to claim 1, wherein the housing comprising a material selected from the group consisting of plastic, aluminum, titanium, stainless steel, and other non-corrosive material.

7. The tag according to claim 1, the twist-tie cable comprising either single strand or braided cable of a material selected from the group consisting of stainless steel, copper, aluminum, titanium, flexible, non-corrosive material and mixtures thereof.

8. An reusable identification tag comprising:
a protective housing;
an electronic circuit positioned at least partially within the housing, the electronic circuit having at least a digital memory; and
at least one twist-tie cable integral to or permanently attached to the housing for attaching the identification tag to an item.

9. The reusable identification tag according to claim 8, wherein the electronic circuit comprises an RFID transponder tag having an antenna and a processor in electrical communication with the digital memory.

10. The reusable identification tag according to claim 8, wherein the digital memory is operable to store identification information for at least one item.

11. The reusable identification tag according to claim 8, wherein the protective housing comprising one or more visual indicia on a face of the tag.

12. The reusable identification tag according to claim 11, wherein the one or more indicia is selected from the group consisting of a brand owner name, a product name, a category name, a color code, a graphic image, a product identification number, a bar code, and combination thereof.

13. The reusable identification tag according to claim 8, wherein the housing comprising a material selected from the group consisting of plastic, aluminum, titanium, stainless steel, non-corrosive material, and mixtures thereof.

14. The reusable identification tag according to claim 8, wherein the twist-tie cable comprises either single strand or braided cable of a material selected from the group consisting of stainless steel, copper, aluminum; titanium, flexible, non-corrosive material and mixtures thereof.

15. The reusable identification tag according to claim 8, further comprising an insulating material surrounding the electronic circuit.

16. An article of manufacture comprising:
an outer casing;
an electronic circuit positioned at least partially within the outer casing, the electronic circuit having at least a digital memory; and
an attachment means for attaching the article to an item.

17. The article of manufacture according to claim 16, wherein the electronic circuit comprises an RFID transponder circuit.

18. The article of manufacture according to claim 17, wherein the RFID transponder circuit comprises an antenna, a digital memory and a microprocessor.

19. The article of manufacture according to claim 18, wherein the digital memory is operative to store an identification number of at least one item.

20. The article of manufacture according to claim 16, further comprising an insulating material surrounding said electronic circuit in said casing.

21. The article of manufacture according to claim 16, wherein the protective housing comprises one or more visual indicia on a face of said tag.

22. The article of manufacture according to claim 21, wherein the one or more visual indicia are selected from the group consisting of a brand owner name, a product name, a category name, a color code, a graphic image, a product identification number and a bar code.

23. The article of manufacture according to claim 16, wherein said outer casing comprises a material selected from the group consisting of plastic, aluminum, titanium, stainless steel, and other non-corrosive material.

24. The article of manufacture according to claim 16, wherein the attachment means comprises at least one twist-tie cable integral to or permanently attached to the outer casing.

25. The article of manufacture according to claim 24, wherein the twist-tie cable comprises either single strand or braided cable of a material selected from the group consisting of stainless steel, copper, aluminum; titanium, flexible, non-corrosive material and mixtures thereof.

26. A method of manufacturing an identification tag comprising:
encapsulating an RFID transponder tag in a protective housing; and
attaching at least one twist-tie cable to the housing.

27. The method according to claim 26, wherein encapsulating comprises surrounding the RFID transponder tag with an insulating material.

28. The method of claim 26, wherein attaching at least one twist-tie cable to the housing comprises a method selected from the group consisting of integrating a flange of the cable into a wall of the housing, inserting a flange of the cable into a cavity in the housing, welding the cable to the housing, and otherwise permanently attaching the cable to the housing.
